(19) United States
(12) Patent Application Publication
(10) Pub. No.: US 2016/0070964 A1
(43) Pub. Date: Mar. 10, 2016

(54) POINT-OF-SALE SYSTEMS AND METHODS FOR MONEY TRANSFER TRANSACTIONS

(71) Applicant: Somerset Information Technology Ltd., Camana Bay, KY (US)

(72) Inventor: Gerald Lee Conrad, Ft. Lauderdale, FL (US)

(21) Appl. No.: 14/846,040

(22) Filed: Sep. 4, 2015

Related U.S. Application Data
(60) Provisional application No. 62/201,232, filed on Aug. 5, 2015.
(60) Provisional application No. 62/150,702, filed on Apr. 21, 2015.
(60) Provisional application No. 62/128,406, filed on Mar. 4, 2015.
(60) Provisional application No. 62/112,772, filed on Feb. 6, 2015.
(60) Provisional application No. 62/047,503, filed on Sep. 8, 2014.

(51) Int. Cl. G06K 9/00; G06Q 20/04; G06Q 20/20; H04N 5/225; H04N 5/232

(52) U.S. Cl. CPC G06K 9/00771; H04N 5/2252; H04N 5/23229; G06Q 20/208; G06Q 20/042

(57) ABSTRACT

Systems and methods for easily and quickly performing financial services with a stand-alone unit are disclosed. In one embodiment, a housing comprising a camera is disclosed. A user interface, such as a tablet computer, may be coupled with the housing. An adjustable mount may be coupled to the housing and configured to rotate about various axes to point the camera and/or a screen on the user interface in various directions. A base may be coupled with and support the adjustable mount and may include a delineated portion indicating a desired location for receiving items of various shapes and sizes to be used for the financial service. The item may then be easily and accurately imaged using the camera. In some embodiments, the camera is fixed on a stand separate from the housing. The base may further include multiple delineated portions.

### INCORPORATION BY REFERENCE TO ANY PRIORITY APPLICATIONS

Any and all applications, for which a foreign or domestic priority claim is identified in the Application Data Sheet as filed with the present application, are hereby incorporated by reference.

This application claims the benefit of priority under 35 U.S.C. §119(e) of U.S. Provisional Application No. 62/201,232, filed on Aug. 5, 2015, and entitled “POINT-OF-SALE SYSTEMS AND METHODS FOR MONEY TRANSFER TRANSACTIONS,” of U.S. Provisional Application No. 62/150,702, filed on Apr. 21, 2015, and entitled “POINT-OF-SALE SYSTEMS AND METHODS FOR MONEY TRANSFER TRANSACTIONS,” of U.S. Provisional Application No. 62/128,406, filed on Mar. 4, 2015, and entitled “POINT-OF-SALE SYSTEMS AND METHODS FOR MONEY TRANSFER TRANSACTIONS,” of U.S. Provisional Application No. 62/112,772, filed on Feb. 6, 2015, and entitled “POINT-OF-SALE SYSTEMS AND METHODS FOR MONEY TRANSFER TRANSACTIONS,” and of U.S. Provisional Application No. 62/047,503, filed on Sep. 8, 2014, and entitled “POINT-OF-SALE SYSTEMS AND METHODS FOR MONEY TRANSFER TRANSACTIONS,” the entirety of each of which is hereby incorporated herein by reference to be considered a part of this specification.

### BACKGROUND

1. Field

This disclosure relates generally to financial services. In particular, features for quick and easy imaging of financial service related-items for use in processing with the system in money transfer transactions are disclosed.

2. Background

A merchant uses a point-of-sale (POS) system or kiosk to conduct money transfer transactions. The typical POS system includes a card reader for payment or prepaid cards and a display. Some POS systems include a cash drawer that can accept or dispense cash to a user or allow the merchant to accept or dispense cash to a customer. A processor in the POS system can perform various money transfer transactions such as initiating a money remittance transaction, loading funds on a prepaid card, check cashing, check deposit, bill pay, refunding cash from a prepaid card, dispensing prepaid cards, loading minutes onto a phone, or other money transfer and financial services.

It is desirable to create a more user-friendly POS system to allow for quicker and more reliable transactions.

### SUMMARY

Various implementations of systems, apparatuses, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In one implementation, an apparatus for performing financial services comprises a base, a camera coupled with the apparatus and comprising a lens, at least one adjustable mount coupled with the base, the at least one adjustable mount configured to rotate about at least one axis, a user interface coupled with the at least one adjustable mount, wherein the base includes a physically delineated portion configured to receive an item related to a financial service processed with the apparatus, and wherein the camera lens is positioned such that the camera lens points at the physically delineated portion.

In some embodiments, the camera lens is configured to be positioned such that the camera lens points at the physically delineated portion of the base when the user interface is oriented substantially horizontally. In some embodiments, the camera lens is configured to be positioned such that the camera lens points at the physically delineated portion of the base when the user interface is oriented substantially vertically. In some embodiments, the apparatus comprises a camera stand supporting the camera. In some embodiments, the user interface is a tablet computer. In some embodiments, a field of view of the camera is configured to cover the entire physically delineated portion. In some embodiments, the user interface is configured to display an image captured by the camera. In some embodiments, the user interface is further configured to display a prompt for a user to input information related to the captured image. In some embodiments, the information is acceptance or rejection of the captured image. In some embodiments, the information is personal information of the user. In some embodiments, the at least one axis is a horizontal axis. In some embodiments, the at least one axis is a vertical axis. In some embodiments, the at least one adjustable mount is configured to rotate about two axes. In some embodiments, the two axes comprise a vertical axis and a horizontal axis. In some embodiments, the at least one adjustable mount is configured to rotate about three axes. In some embodiments, the three axes comprise a vertical axis, a horizontal axis, and a third axis perpendicular to a display of the user interface. In some embodiments, the apparatus comprises a stand coupling the at least one adjustable mount with the base. In some embodiments, the stand is configured to extend. In some embodiments, the apparatus comprises a light. In some embodiments, the apparatus comprises a reader coupled to the base. In some embodiments, the reader is a card reader. In some embodiments, the physically delineated portion comprises at least one recess defined by the base. In some embodiments, the apparatus comprises a transparent cover positioned over the delineated portion. In some embodiments, the cover is rotatably coupled with the base. In some embodiments, the item is a check or identification document, the at least one recess is shaped to receive the check or identification document, and the camera is configured to capture an image of the check or identification document. In some embodiments, the apparatus comprises a cash drawer.

In another implementation, a method for performing financial services using an apparatus comprising a user interface, a camera, an adjustable mount, and a base, wherein the base comprises a physically delineated portion configured to receive an item related to a financial service processed with the apparatus, comprises selecting a transaction using the user interface, positioning the item within the physically delineated portion of the base, and capturing an image with the camera of the item while the item is positioned within the physically delineated portion.

In some embodiments, the method comprises positioning the camera such that a lens of the camera points at the item positioned in the physically delineated portion of the base. In some embodiments, the camera is coupled with the user interface, and positioning the camera comprises positioning the user interface substantially vertically. In some embodiments, the camera is coupled with the user interface, and positioning the camera comprises positioning the user interface substantially horizontally. In some embodiments, a field of view of the camera is configured to cover the entire physically delineated portion. In some embodiments, the item is a check or money order. In some embodiments, capturing an image of the item comprises capturing an image of the front and back of the item. In some embodiments, the method comprises entering on the user interface an amount indicated on the check or money order. In some embodiments, the item is at least one of an identification document and a bank check.

In another implementation, an apparatus for performing financial services comprises a base, a user interface coupled to the base, means, coupled with the base, for positioning documents related to financial services processed by the apparatus, and means for capturing images of the documents positioned with the means for positioning documents.

In some embodiments, the apparatus further comprises means for flattening the documents when the documents are positioned with the means for positioning documents.

In another implementation, an apparatus for performing financial services comprises a base, a mounting structure coupled to the base, a user interface coupled to the mounting structure, a camera coupled to the user interface or to the mounting structure and comprising a lens, wherein the apparatus comprises a surface having defined thereon a physically delineated portion configured to receive an item related to a financial service processed with the apparatus, and wherein the camera lens is positioned such that the camera lens points at the physically delineated portion defined on the surface.

In some embodiments, the apparatus comprises a cover coupled with the base. In some embodiments, the cover is rotatably coupled with the base. In some embodiments, the cover is transparent. In some embodiments, the base is rotatable. In some embodiments, the surface that contains the physically delineated portion is angled from horizontal. In some embodiments, the user interface comprises a display. In some embodiments, the user interface comprises two displays. In some embodiments, the surface having defined thereon a physically delineated portion is positioned between the two displays. In some embodiments, the camera is coupled to a rear surface of the mounting structure and the display is coupled to a front surface of the mounting structure.

### BRIEF DESCRIPTION OF THE DRAWINGS

FIG. 1 is a perspective view of an embodiment of an exemplary point-of-sale (POS) system.

FIG. 2 is a rear perspective view of the exemplary POS system of FIG. 1.

FIG. 3 is a front view of the exemplary POS system of FIG. 1.

FIG. 4 is a side view of the exemplary POS system of FIG. 1.

FIG. 5 is a perspective view of the exemplary POS system of FIG. 1 with a user interface and housing of the POS system parallel to a base of the POS system, in accordance with embodiments described herein.

FIG. 6 is a perspective view of the exemplary POS system of FIG. 1 showing an image on a screen of the user interface of the POS system, in accordance with embodiments described herein.

FIG. 7 is an exploded view of the exemplary POS system of FIG. 1, in accordance with embodiments described herein.

FIG. 8 is a perspective view of another embodiment of an exemplary POS system that includes a cash drawer.

FIG. 9 is a perspective view of another embodiment of an exemplary POS system.

FIGS. 10A-10B are front perspective views of another embodiment of an exemplary POS system.

FIG. 10C is a rear perspective view of the exemplary POS system of FIGS. 10A-10B.

FIGS. 11A-11C are front, rear, and side views of an alternative embodiment of an exemplary POS system.

FIGS. 12A and 12B show two different dual-screen embodiments of POS systems.

FIG. 13 is a flowchart showing an embodiment of a method for performing a financial transaction using an exemplary POS system.

Like reference numbers and designations in the various drawings indicate like elements.

### DETAILED DESCRIPTION

Various aspects of the novel systems, apparatuses, and methods are described more fully hereinafter with reference to the accompanying drawings. The disclosure is modular by intent, and as such may, however, be embodied in many different forms and should not be construed as limited to any specific structure or function presented. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Features are disclosed herein for systems, devices and methods for a point-of-sale (POS) system. The system and associated methods allow for an easy and convenient solution for performing various tasks and services related to financial transactions. Some of these tasks and services include sales of items, exchange of money, sending/receiving money, authenticating various financial-related items or documents such as identification, bank checks, or money orders, and other tasks and services. The system and methods may be used and/or performed by various users, such as customers, buyers, sellers, retailers, sales agents, cashiers, and the like. The system and methods allow such users to easily image a financial service-related item to conduct a financial transaction.

The system may be embodied in a standalone kiosk or unit that can be easily transported, moved, adjusted, etc. The system may include a base defining one or more delineated portions where one or more financial service-related items may be securely placed and easily imaged with a camera or camera module, such as a custom configured camera module, that is included with the system. As used herein, “camera” and “camera module” are used interchangeably. The camera or camera module and supporting structures are designed so that they can be easily manipulated to reduce the likelihood of “operator error” and thereby ensure an accurate or otherwise useful image is taken of the item. The system may further include a user interface, such as a touch screen computer tablet or the like, mounted on or coupled with an adjustable mount that allows for easy manipulation and movement of the interface, so that users located on various sides of the system may easily use the user interface. For instance, the user interface may rotate about various axes to provide optimal convenience to users on opposite sides of the system. Thus, financial items may be quickly and repeatedly imaged for use in financial services that are processed with the system, such as with an onboard computer or a computer network to which the system is connected. One advantage of the systems and associated methods therefore is quickly and accurately processing a large number of such financial services for a large number of users, without causing undue delay or waiting time for other users.

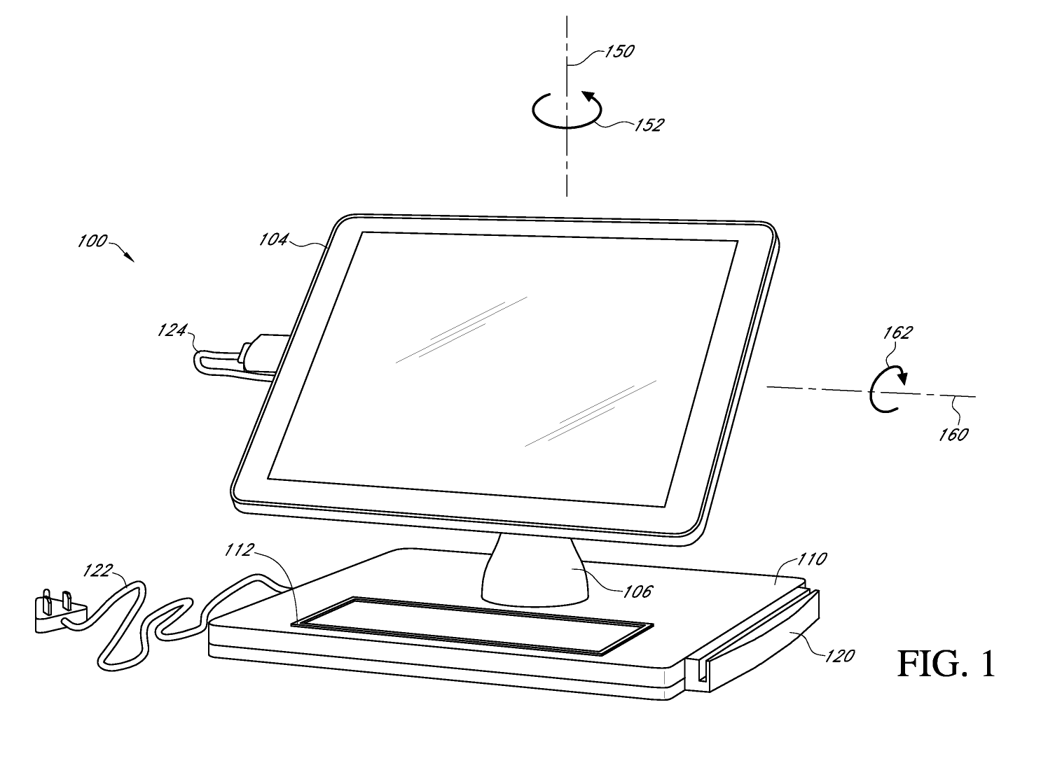

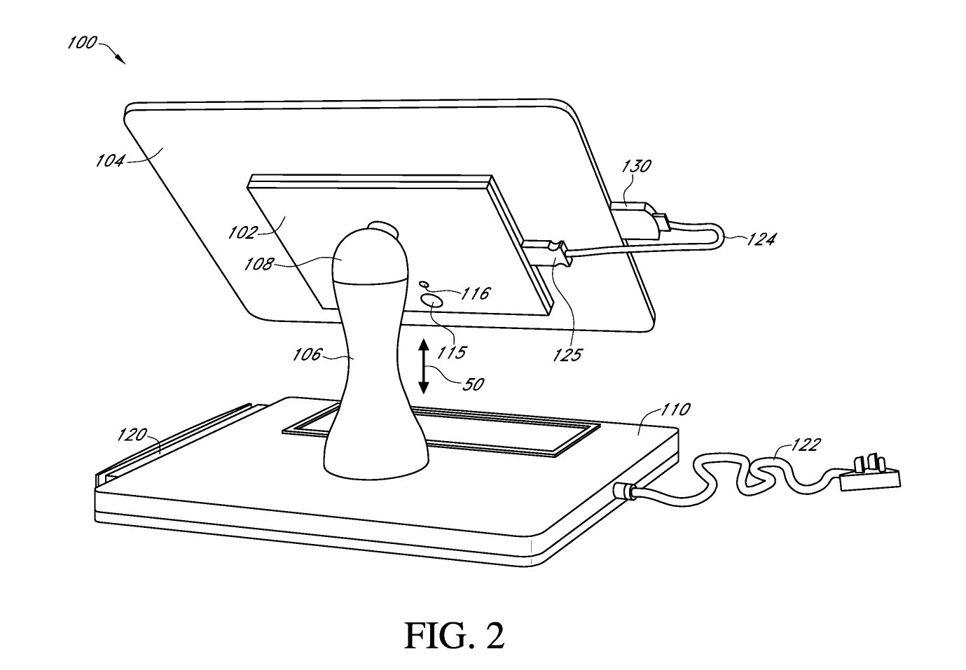

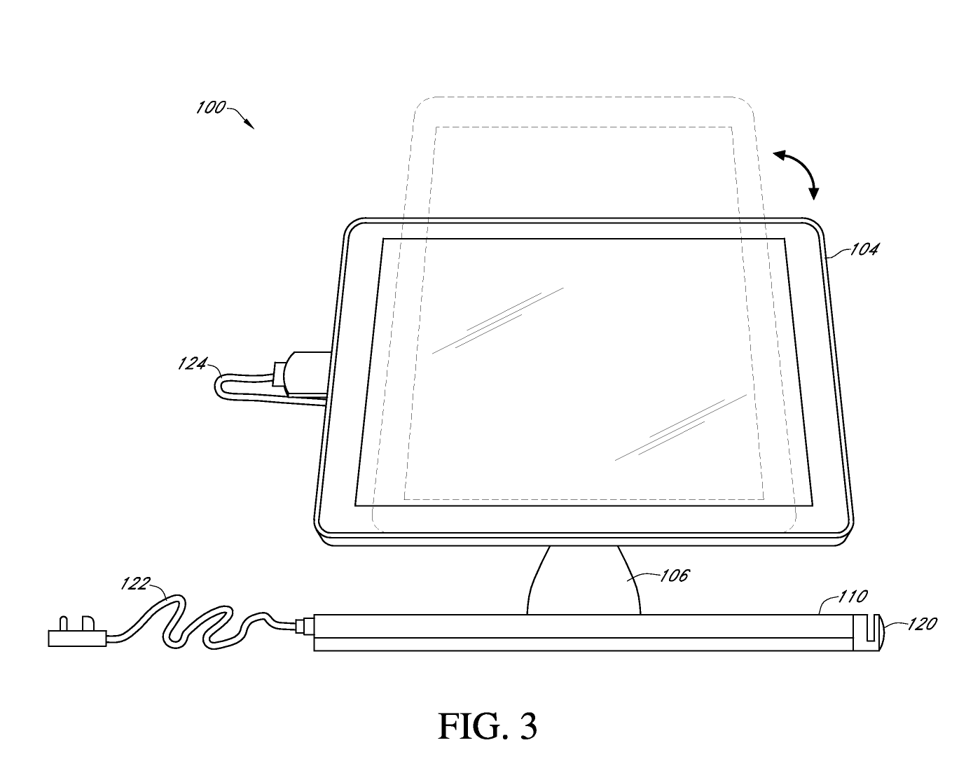

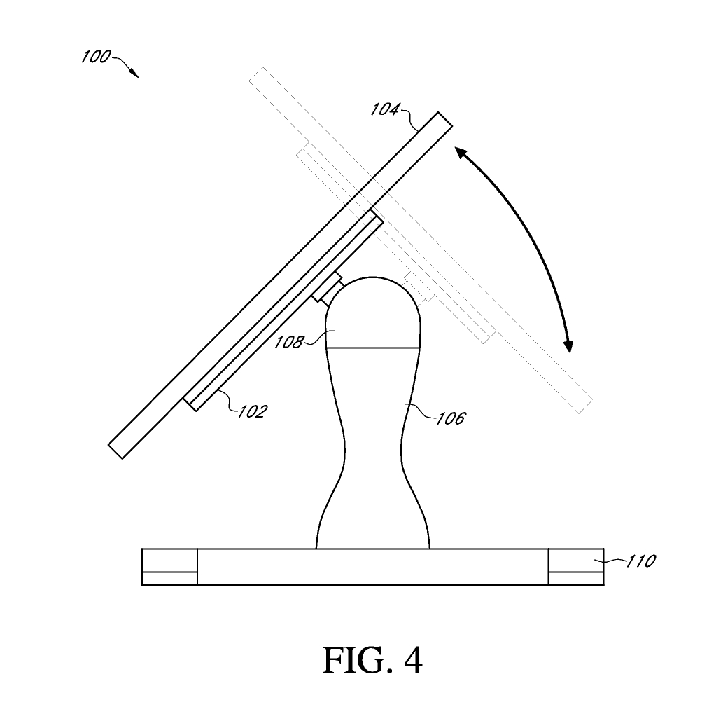

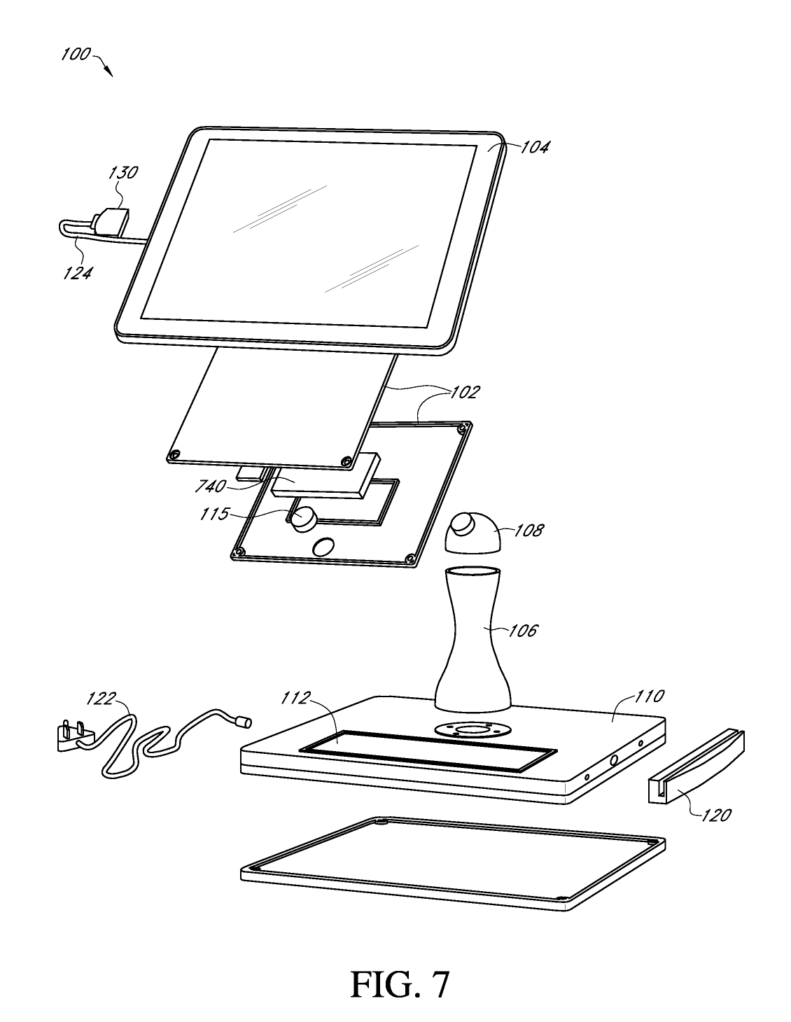

FIGS. 1-7 illustrate an exemplary point-of-sale (POS) system 100. FIGS. 1, 5 and 6 are perspective views of the system 100 in various configurations, FIG. 2 is a rear perspective view of the system 100, FIG. 3 is a front view of the system 100, FIG. 4 is a side view of the system 100, and FIG. 7 is an exploded view of the system 100. The system 100 may comprise a user interface 104, a stand 106 to which the user interface is attached, an adjustable mount 108 (see FIGS. 2, 4, 5 and 7) coupled to the user interface 104 and the stand 106, and a base 110 coupled to the stand 106. The system 100 may also comprise a reader 120 such as a card reader, a power source connection 122, and a data connector 124. The user interface 104 may comprise an operating system and a thin client application which provides a graphical user interface and/or a web browser to a user for processing financial transactions using software resident on a remote server, for example. The thin client terminal may depend heavily on its server to perform its computational functions which can allow a low-cost computer user interface 104, such as a low-cost tablet computer, to be used in the system 100 as a possible alternative to a relatively expensive tablet or computer that is in many respects a complete general purpose personal computer, such as a commercially available computer or tablet. The system 100 may also comprise global positioning system (GPS) functionality. In some embodiments, the user interface 104 may comprise GPS software to allow GPS capability.

As can be seen in FIGS. 2 and 7, in some embodiments of the system 100, a camera 115 may be located in, on or be otherwise coupled with a housing 102. The housing 102 may be positioned between the mount 108 and the user interface 104. The housing 102 may couple the mount 108 to the user interface 104. The user interface 104 may also comprise software to operate the camera 115.

As shown in FIG. 2, the housing 102 may attach to the back of the user interface 104. The housing 102 may facilitate secure connection of the user interface 104 within the system 100 and may provide the benefit of additional security of the user interface 104 to prevent theft in public places. The housing 102 may be attached to the back of the user interface 104 using screws (not shown) or other fixation means (e.g., adhesives, pins and recesses, mechanical locking, etc.). For example, the housing 102 or user interface 104 may comprise an aperture that is configured to receive a mechanical fastener, e.g., a screw or bolt, from the user interface 104 or housing 102, respectively. This configuration permits the user interface 104 to be secured to the stand 104 in such a manner that although the user interface 104 may be detachable (e.g., by removing the screw) it cannot be quickly removed, thereby preventing a quick theft of or tampering with the user interface 104. In some implementations, the screw may comprise a specialized head that requires a special tool to remove. Such a specialized tool may only be possessed by the merchant for additional security. The housing 102 may be configured to attach and secure different sized user interfaces 104 to the housing 102. In some embodiments, the housing 102 may be attached to other portions of the user interface 104. For example, the housing 102 may comprise a clear plastic case (not shown) in which the user interface 104 inserted. The housing 102 may be configured to allow touch screen capability through the case and may provide additional security against theft or damage to the screen. In some embodiments, the housing 102 may be configured to attach and secure to two user interfaces 104. This may include, for instance, a primary user interface assembly, and an optional secondary user interface assembly that can be pre-installed, or installed at a later time in the active deployment environment. For example, the back portions of the two user interfaces 104 may each attach to the housing 102. In other embodiments, the housing 102 may comprise two or more portions and the two user interfaces 104 may each attach to different portions of the housing 102. In embodiments comprising two user interfaces 104, the user interfaces 104 may display at least some of the same information to both a customer and a merchant agent to allow for sharing of transaction information.

The housing 102 may also comprise one or more data ports to allow connection to peripheral devices or data transfer. As shown in FIG. 2, the housing 102 may comprise a Universal Serial Bus (USB) port which couples with the USB plug 125 on one end of the data connector 124. The other end of the data connector 124 may comprise a connector 130, such as a dock connector, which connects to the user interface 104. In some embodiments, the data connector 124 may comprise a Lightning to USB cord. The connector 130 may comprise a 30-pin dock connector which is coupled to the user interface 104. In some embodiments, the connector 130 may comprise an 8-pin or other dock connector. The connection between the user interface 104 and the housing 102 may facilitate communication between the user interface 104 and peripheral devices of the system 100. For example, if a user uses a card at the reader 120, e.g., a magnetic, near field communication (NFC), or chip card reader, a central processing device 740 (see FIG. 7) in the housing 102 may receive the card data via a connection through the base 110 and stand 106, for example, and send it to the user interface 104 through the data connector 124. The central processing device 740 may control communications between the user interface 104 and other peripheral devices (e.g., biometric fingerprint reader, retina scanner, money order printer, customer facing camera, receipt printer or cash drawer). The central processing device 740 may be positioned in a back portion of the housing 102 (as shown in FIG. 7), although other locations, such as in the base 110, are possible.

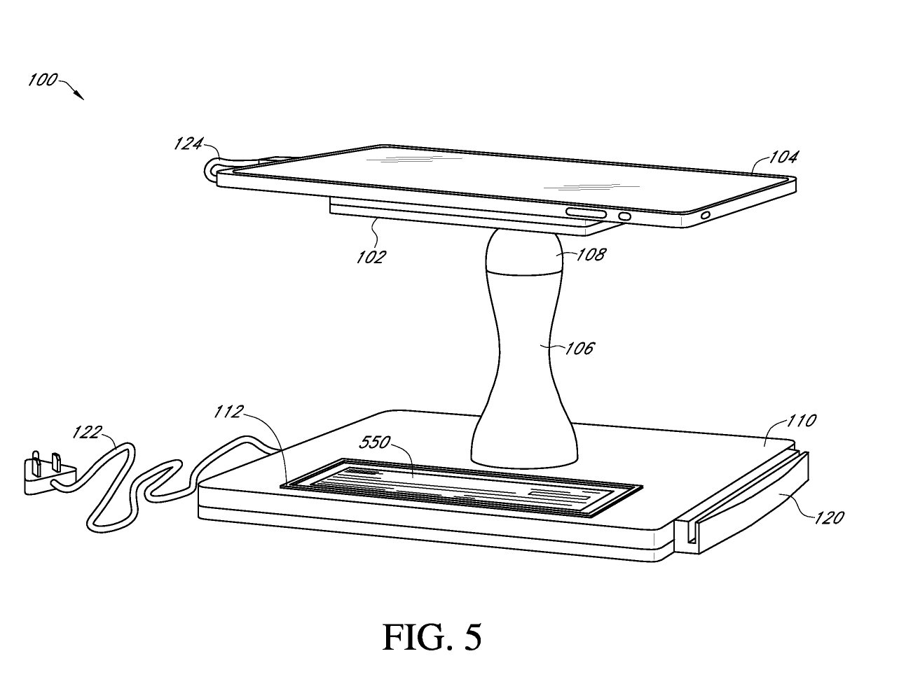

The housing 102 may also be coupled to the adjustable mount 108. As shown, the adjustable mount 108 is configured to allow 360° rotation about a vertical axis 150 and may also be configured to provide pivotal rotation about a horizontal axis 160. For example, as shown in FIG. 1, when facing the user interface 104 display, a user, such as either a customer or a merchant agent, can turn the user interface 104 to the right or left, in the direction indicated by the arrow 152 about the axis 150, so as to see the back of the user interface 104 or to show the display to a person on the opposite side of the POS system 100. In some embodiments, a user can tilt the user interface 104 forward or backward, for instance in direction indicated by arrow 162 about the axis 160. This may allow one to see the front of the user interface 104 display or the back of the user interface 104, as shown in FIG. 4. Additionally with reference to FIG. 3, the head 108 may allow a user to rotate the user interface 104 clockwise or counter-clockwise about an axis perpendicular to the screen of the user interface 104 (not shown)—for example, to place the user interface 104 in a landscape or portrait orientation. This configuration allows the user to adjust the user interface 104 in any manner to allow a comfortable viewing of the user interface 104 display and facilitates sharing of the user interface 104 contents between a user and a third party (e.g., a merchant agent). In some implementations, the adjustable mount 108 includes stops so that the user interface 104 and housing 102 are limited to rotation between a first orientation and a second orientation. Alternatively, or in addition, the adjustable head 108 can include detent mechanisms to hold the user interface 104 in the first orientation or second orientation unless a sufficient torque is applied by the user. For example, the first orientation may comprise the configuration illustrated in FIG. 1 and the second orientation may comprise the configuration illustrated in FIG. 5. As it may be desirable for a user to show the screen to a merchant agent and vice-versa, the user or merchant agent may either turn or swivel the user interface 104 by 180 degrees about a horizontal or vertical axis, such as vertical axis 150 or horizontal axis 160, to show the screen to the other. As various actions are completed, each party may turn or swivel the user interface 104 back to the other. When the user interface 104 faces the user, the user may enter confidential or sensitive information on the user interface 104 display. In some embodiments, the user interface 104 may comprise security measures to keep such information secure. For example, if the user enters a signature or PIN, the user interface 104 may be configured to meet payment card industry (PCI) security standards and never display the input.

The adjustable mount 108 may also be coupled to the stand 106. The stand 106 may be configured to provide an adjustable height of the user interface 104 in the POS system 100 to allow for more comfortable viewing of the user interface 104 screen for users of different heights. For instance, the stand 106 may lengthen along the direction indicated by the arrow 50. In some embodiments, the stand 106 may extend and/or contract along the direction indicated by the arrow 50. The stand 106 may also provide a secure connection to the base 110 through the use of screws or other structures for connecting the stand 106 to the base 110.

The base 110 comprises a physically delineated portion 112. The physically delineated portion 112 may comprise a recess defined by the base 110, a painted or printed rectangular border on the base 110, a raised structure on the base 110, or other marking or physical characteristic of the surface to indicate a desired location for positioning various documents. These documents may be items related to financial services processed by the system 100, such as a check, money order, or identification document, which may be utilized during an image capture of the documents. In some embodiments, the physically delineated portion 112 may comprise one or more recesses, painted borders, or other markings or structures to indicate a desired placement for different sized documents. For example, the physically delineated portion 112 may comprise a first recess of a first size for a user's identification document (e.g., driver's license, passport, state identification card, etc.). The physically delineated portion 112 may also comprise a second recess of a second size for personal checks. The physically delineated portion 112 may also comprise a third recess of a third size for commercial checks. In some embodiments, the first recess may be positioned within the second recess which is positioned within the third recess. In other embodiments the first, second, and third recesses may be positioned in non-overlapping portions of the base 110. The physically delineated portion 112 may also comprise a raised structure, whether on the base 110 or otherwise. For instance, the physically delineated portion 112 may be a raised portion of the base 110 and have thereon any or all of the features of the recess as described herein. Further, while the physically delineated portion 112 may be on, in or otherwise defined by the base 110, the physically delineated portion 112 may also be in other locations, such as on a structure that is separate from the base.

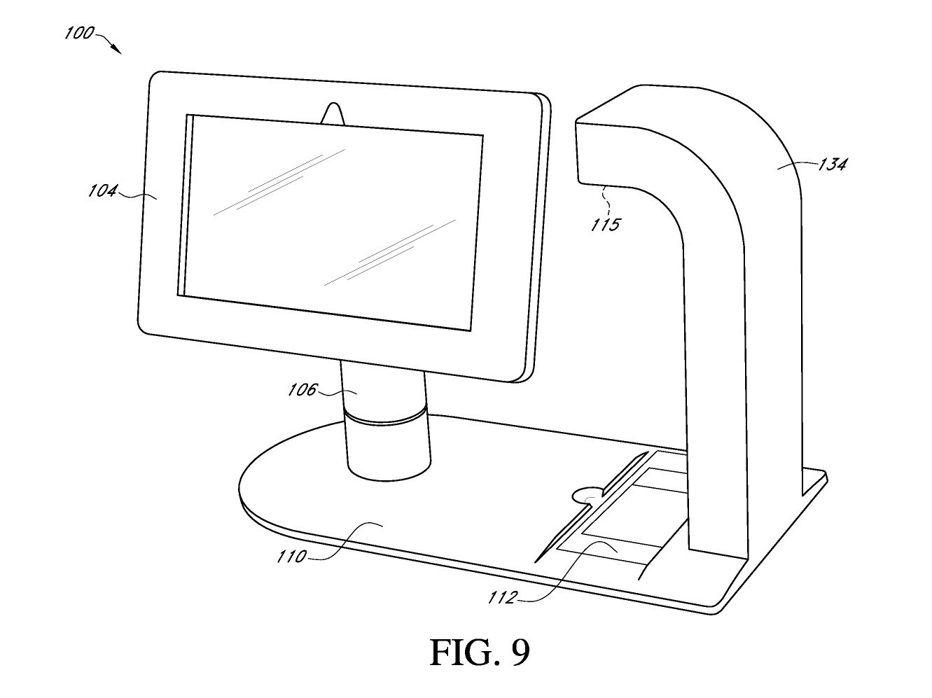

As shown in FIG. 2, a camera 115 may be located within the housing 102. The camera 115 may be positioned such that when the housing 102 is parallel to the base 110, the camera 115 lens is pointed directly at the physically delineated portion 112. In some embodiments (for example, in FIG. 9), the camera 115 may be configured in a fixed position above the physically delineated portion 112 such that images of documents placed within the one or more portions (e.g., recesses, painted borders, etc.) of the physically delineated portion 112 are accurately imaged, for instance, for optical character recognition (OCR) or remote deposit capture (RDC) purposes. In some embodiments, the area to be captured by the camera 115 may comprise the entire physically delineated portion 112. In other embodiments, the camera 115 may a component of the user interface 104 and located on a back portion of the user interface 104 or may be a separate component of the system 100. The system 100 may further comprise a light 116 to provide additional lighting during an image capture (e.g., a flash). As shown in FIG. 2, the light 116 may be a component of the housing 102 and located adjacent to the camera 115. In some embodiments, the light 116 may be coupled to the user interface 104 or a separate component.

As discussed above, the system 100 may facilitate certain money transfer transactions, such as check cashing or check deposit. When performing check cashing or deposit, the user interface 104 or a software application of the user interface 104 may require the user and/or merchant agent to take a picture of the check or money order (e.g., the front and back) to validate the transaction. In some embodiments, the user or merchant agent may position the housing 102 above the physically delineated portion 112 such that the camera 115 is directed at the physically delineated portion 112. The user interface 104 may display a live video or display of the camera 115's line of sight. FIG. 5 is a perspective view of the system 100, illustrating a configuration with the housing 102 and user interface 104 oriented parallel to the base 110 and the camera 115 (not shown) pointed at the physically delineated portion 112. In some implementations, the adjustable mount 108 may include a visual or tactile indication to the user that the user interface 104 is in the correct configuration, for example horizontal, to capture an image. The visual or tactile indication may be alignment marks or a spring biased ball that can enter and exit a recess for a snap-in indication of proper horizontal orientation.

As shown in FIG. 5, a check 550 may be positioned within the physically delineated portion 112. The user or merchant agent may then view the user interface 104 display to confirm a substantially clear view of the check 550 located in the marked portion 112. The user may then take a picture of the check in the physically delineated portion 112 and indicate on the screen of the user interface 104 whether to accept or reject the picture taken.

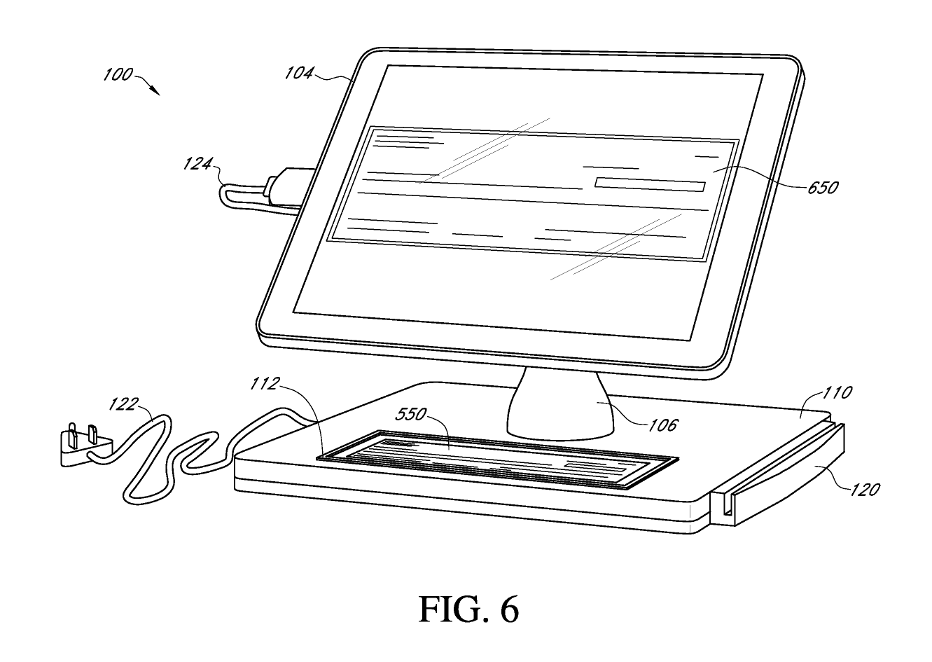

FIG. 6 is a perspective view of the system 100, illustrating a configuration after the user takes a picture of the check 550 and the image 650 of the check 550 is displayed on the screen of the user interface 104. In some embodiments, the user interface 104 may contain image processing software that may read the image 650 of the check 550 and determine the check amount. In other embodiments, the customer or merchant agent may enter the check amount manually on the user interface 104 display.

As mentioned, the system 100 may also comprise the reader 120, which may be a card reader such as a credit card swipe machine. The reader 120 may also be other types of readers, such as a scanner, for reading other types of objects, such as codes on a mobile phone display. As shown in FIGS. 1-3 and 5-8, the reader 120 may be coupled to the base 110. In some embodiments, the reader 120 may be coupled to the user interface 104 directly or may be a separate component. The reader 120 may be configured to read one or more types of cards (e.g., credit cards, debit cards, or prepaid cards). In some embodiments, the card reader may have the capability to read a magnetic stripe, Near Field Communication (NFC), QR codes, 2D bar codes, chip cards, or others.

The base 110 may also comprise a power source connection 122. The power source connection 122 may be a power cord which connects the base 110 to an electrical outlet or other power source to provide power to the system 100. In some embodiments, the power source connection 122 may be coupled to the user interface 104, the housing 102, or other component of the system 100. In some embodiments, the system may comprise a printer (not shown) for printing a receipt or summary of a transaction. In some implementations, the printer may be coupled to the base 110. In some embodiments, there may be multiple power cords for powering dual tablets and/or other electronic components that, for instance, cannot be USB powered.

FIG. 7 is an exploded view of the system 100. As shown, the central processing device 740 may be located within the housing 102. In some embodiments, the central processing device 740 may be located within the base 110 or other component of the POS system 100. Additionally, FIG. 7 illustrates possible locations for screws and connection points for the various components of the system 100.

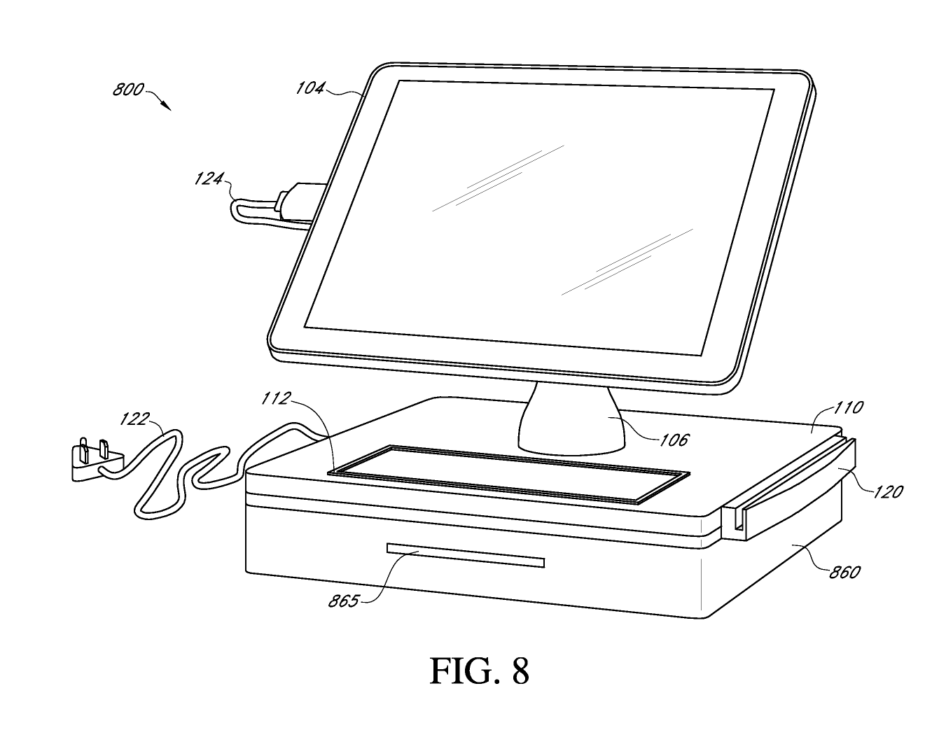

FIG. 8 is a perspective view of a POS system 800 comprising a cash drawer 860. The system 800 illustrated in FIG. 8 may be similar to and adapted from the system 100 illustrated in FIGS. 1-7. Elements that may be common to both share common reference indicia. It is understood that features or functionalities described with respect to the embodiment of the system 100 may also apply to the embodiment of the system 800, and vice versa.

The system 800 may comprise a cash drawer 860 coupled to the base 110. The cash drawer 860 may include one or more slots 865. The cash drawer 860 may comprise a slot 865 for dispensing or receiving cash. The cash drawer may also comprise a slot 865 for dispensing or receiving cards (e.g., prepaid cards or credit/debit cards). The cash drawer 860 may securely hold cash in the system 100 and a merchant or the merchant's agents may be able to open the cash drawer 860 by use of a passcode, a key, or other unlocking means. In some embodiments, the housing 102, and more specifically, the central processing device 740, can control whether to open the drawer 860. For example, when conducting a transaction, a merchant agent can choose to process payment with cash or card. If a cash payment is selected, a software application of the user interface 104 can send a signal to the central processing device 740, which can open the cash drawer 860.

FIG. 9 illustrates an embodiment of a POS system 900 where the camera 115 is supported above the physically delineated portion 112 of the base 110 by a second stand 134. The stand 134 is shown as an elongated structure with a curved top portion. However, the stand 134 may be in various configurations and orientations, such as completely straight, completely curved, or combinations thereof. The stand 134 may have a rectangular cross-section, as shown. In some embodiment, the stand 134 may have different shaped cross-sections, such as square, round, triangular, others, or combinations thereof. In this embodiment, the user need not adjust the orientation of the user interface 104 to acquire images of documents placed in the physically delineated portion 112. The system 900 may also include the light 116 (not shown), the base 110, the stand 106, and the user interface 104. The system 900 may further include any of the features and functionalities of the system 100 described with respect to FIGS. 1-7 and/or the system 800 described with respect to FIG. 8, and vice versa.

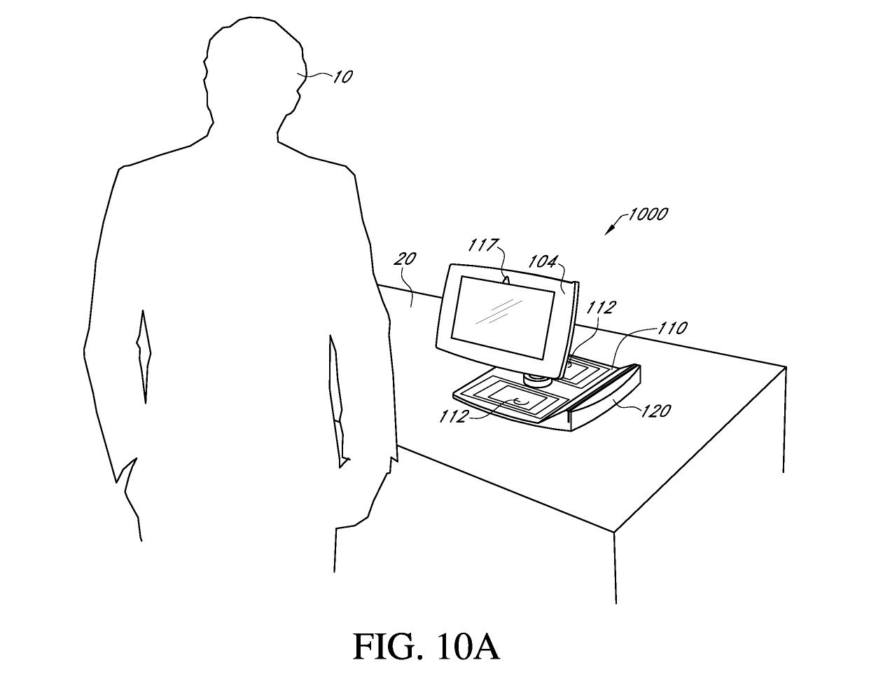

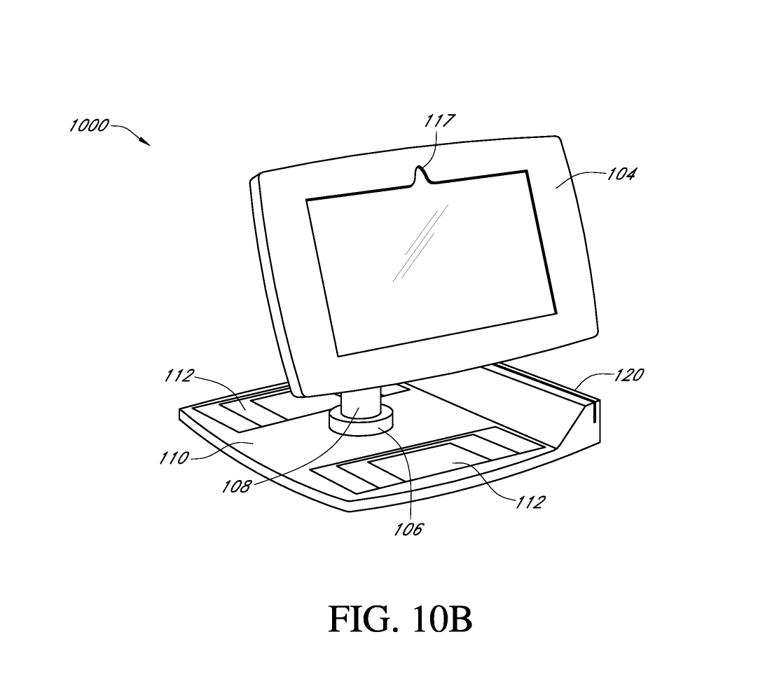

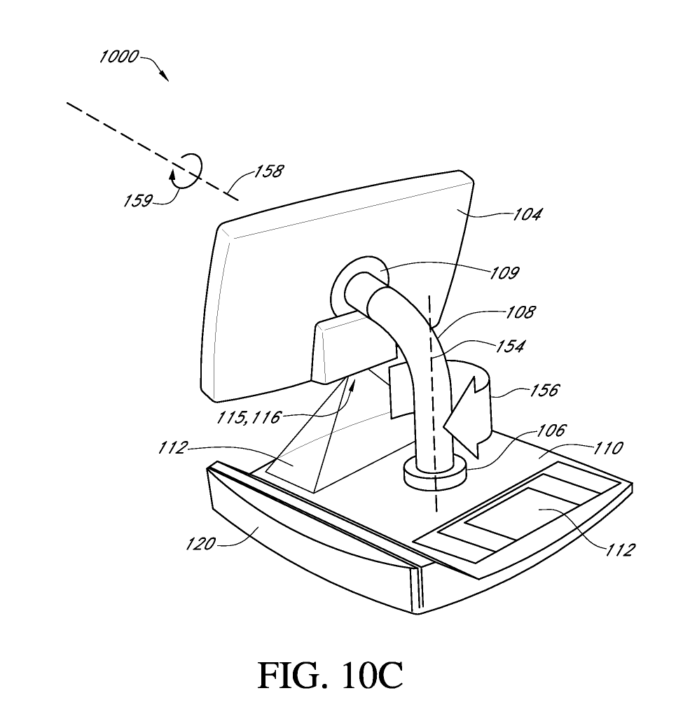

FIGS. 10A and 10B depict front perspective views of another embodiment of a POS system 1000. FIG. 10C depicts a rear perspective view of the system 1000. The system 1000 may include a base 110, a user interface 104, a reader 120, and multiple delineated portions 112. As shown in FIG. 10A, the system 1000 may be mounted or otherwise supported by a support 20 and used by a user 10. The user 10 may be a financial services customer, or any other person, that is using the system 1000. For example, the user 10 could be a customer in a convenience store who is sending money to a relative. The support 20 may be a checkout counter, or other supporting structure, on which the system 1000 may be located.

As shown, the system 1000 may include two delineated portions 112. In some embodiments, the system 1000 may include more than two delineated portions 112. The multiple delineated portions 112 may be located at various areas of the base 110. As shown, a first delineated portion 112 may be near one end of the base 110. A second delineated portion 112 may be opposite the first delineated portion 112 on another end of the base 110. This is merely one arrangement of multiple delineated portions 112 that may be incorporated in the system 1000. Other suitable configurations and/or quantities of delineated portions 112 defined by the base 110 may be implemented.

In some embodiments, the system 1000 may include more than one camera. For instance, the system 1000 may include a second camera 117 in addition to the camera 115. As shown in FIGS. 10A and 10B, the second camera 117 may be on a front surface of the user interface 104. Therefore, the system 1000 may include the camera 115 and the second camera at 117. The camera 115 may be used to capture images of financial services items while the second camera 117 may be used to capture images of the user 10.

FIG. 10C is a rear perspective view of the system 1000. As shown, the system 1000 may include a base 110 coupled to the stand 106. The stand 106 may be coupled to the adjustable mount 108. The adjustable mount 108 may be coupled with a fitting 109. The fitting 109 may be coupled with the user interface 104.

The stand 106 and adjustable mount 108 may be various shapes and sizes. As shown in FIG. 10C, the stand 106 may be short compared to the length of the adjustable mount 108. The stand 106 is shown as a stubby, circular supporting structure that couples the adjustable mount 108 to the base 110. The adjustable mount 108 may be a tubular structure coupled with the stand 106 and the fitting 109. In some embodiments the adjustable mount 108 is a hollow tube. By using a hollow tube or other similar structure for the adjustable mount 108, wiring from the user interface 104 may extend through the adjustable mount 108. Therefore, wiring, such as cables, from the user interface 104 maybe extend through the adjustable mount 108 and connect to other portions of the system 1000, such as the base 110 or the reader 120.

The adjustable mount 108 may be configured to rotate about various axes. As shown, the adjustable mount 108 may rotate about a vertical axis 154 in the direction indicated by the arrow 156. It is understood that the adjustable mount 108 may also rotate about the vertical axis 154 in a direction opposite the direction indicated by the arrow 156. In this manner, the user interface 104 may be swiveled, pivoted rotated or otherwise oriented or reoriented such that the user interface 104, and other components coupled with the user interface 104 such as the camera 115, are oriented closer to another delineated portion 112 of the base 110. In some embodiments, there are two delineated portions 112 defined on opposite ends of the base 110. The adjustable mount 108 may be rotated about the vertical axis 154 such that the user interface 104 may be positioned over either delineated portion 112. In embodiments with more than two delineated portions 122, such as three or more delineated portions 112, formed by the base 110, the adjustable mount 108 may be rotated about the vertical axis 154 such that the user interface 104 may be located adjacent to any of the three or more delineated portions 112. In this manner, the camera 115 may be positioned so that it may capture an image of a financial services item located on any of the delineated portions 112.

Referring to FIG. 10C, the system 1000 may include a camera 115 (not shown) that is oriented such that the camera 115 points at the delineated portion or portions 112 when the user interface is substantially vertical. The camera 115 may be coupled with the user interface 104 such that a field of view of a lens of the camera 115 covers the entire delineated portion 112, for instance when the user interface is substantially vertical. Further, the system 1000 may include a light 116 (not shown) that may illuminate the delineated portion 112. In some embodiments, the light 116 may illuminate the delineated portion 112, and any items received thereon, while the camera 115 captures an image of the delineated portion 112 and any items received thereon. Therefore, the camera 115 may be oriented in various configurations. This is just one example of how the camera 115 may be oriented. Other suitable configurations are possible.

The system 1000 may further include a fitting 109. The fitting 109 may be a hat section bracket that couples the adjustable mount 108 to the user interface 104. In some embodiments, the user interface 104 may swivel or otherwise rotate about an axis 158 that is perpendicular to a display on the front of the user interface 104. The user interface 104 may rotate about the axis 158 in a direction indicated by the arrow 159. It is understood that the user interface 104 may also rotate in a direction opposite of that indicated by the arrow 159.

It is understood that any of the features or functionality described herein with respect to one of the embodiments of the system may apply to other embodiments of the system as well. For example, the camera 115 configuration of the system 1000 described with respect to FIGS. 10A-10C may be implemented in the system 100 described with respect to FIGS. 1-8, and vice versa. As another example, the embodiment of the adjustable mount 106 in the system 100 described with respect to FIGS. 1-8 may be implemented in the system 1000 described with respect to FIGS. 10A-10C. These are merely some examples, and other combinations of different embodiments of the various components are within the scope of the present disclosure.

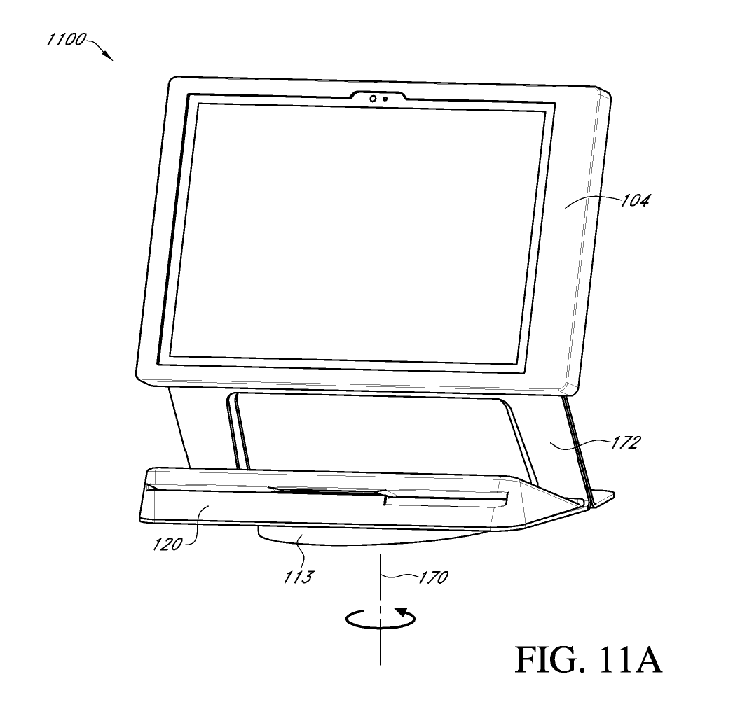

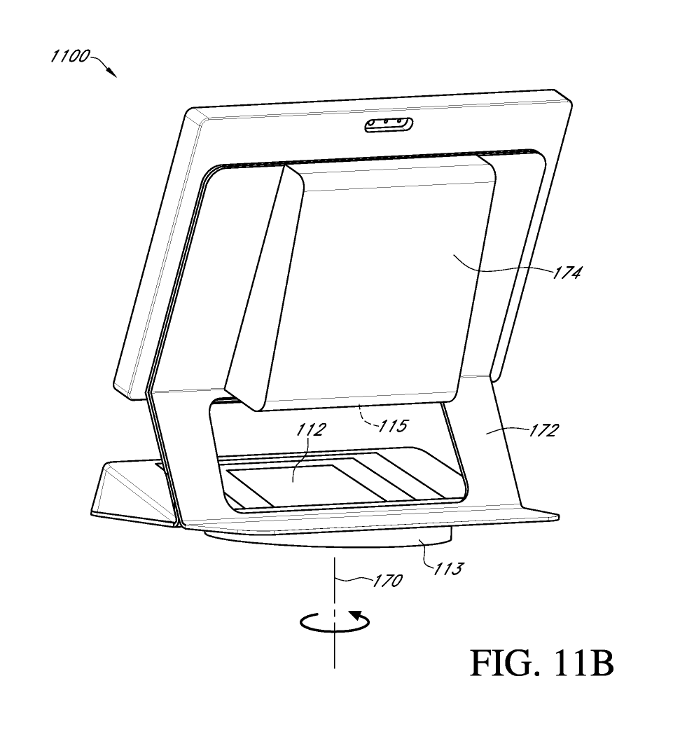

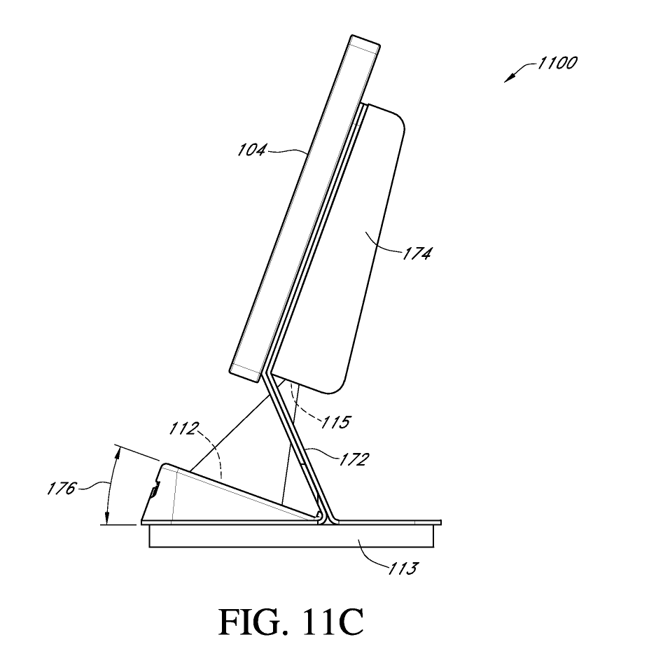

An additional alternative embodiment 1100 is illustrated in FIGS. 11A, 11B, and 11C. In this implementation, a base 113 is rotatable turntable with top surface and bottom surface rotatable with respect to each other in a “lazy susan” fashion. When placed on a counter, desktop, or table, the bottom surface rotates with respect to the top surface around an axis 170. A mounting structure 172 is coupled to the top surface of the base 113. This mounting structure has attached thereto a user interface 104, which may comprise a display, and an enclosure 174 for electronics such as a camera 115.

Also attached to the top surface of the base 113 is an enclosure containing a card reader 120. The top surface of this enclosure includes the physically delineated portions 112 as described above. This surface may be angled with respect to the horizontal by an angle 176, which may advantageously be between 10 degree and 30 degrees, preferably between 15 degrees and 25 degrees.

This particular implementation has the advantage that the relationship between the camera lens and the physically delineated portions 112 remains fixed, while the user interface 104 remains rotatable to face a customer or cashier as desired.

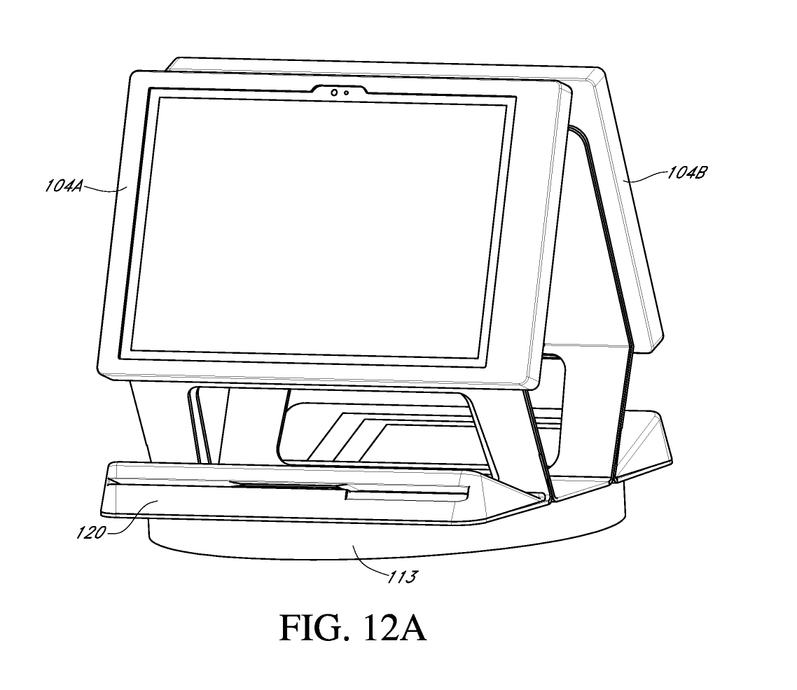

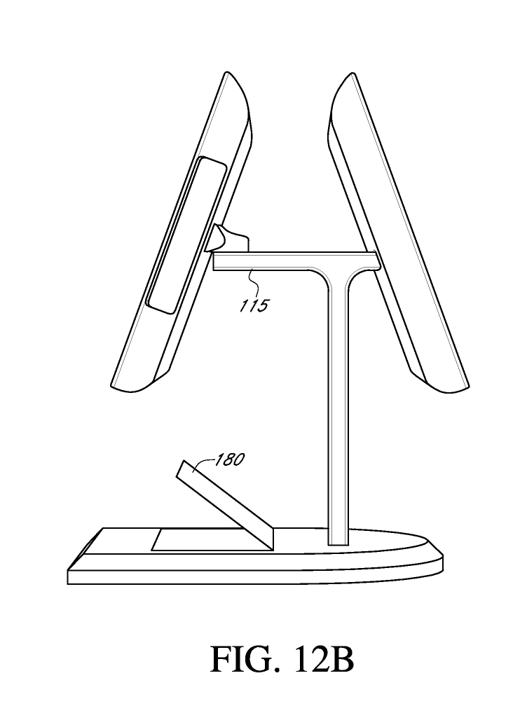

It is also possible to include two displays instead of one as shown in the above embodiments. In such a “dual screen” embodiment, the rotation aspects of the system described above may or may not be provided. For example, shown in FIG. 12A is a dual screen implementation of the single screen embodiment of FIGS. 11A-11C. In the implementation of FIG. 12A, two screens 104A and 104B are provided, facing in opposite directions. One screen may face the agent, teller, or cashier, while the other screen faces the customer. When the agent is processing a transaction, advertisements or other content can be displayed to the customer. In the embodiment of FIG. 12A, the turntable 113 is also provided, so that if the customer needs or wants to see the display presented to the agent, the unit can rotate to allow that as described in detail above. As an alternative, the turntable could be omitted, and the display presentation on the agent facing screen could be transferred or reproduced on the customer facing screen when desired.

In the embodiment of FIG. 12A, the physically delineated portions 112 for document placement and imaging are also duplicated on both sides of the unit, so either the customer or the agent can place documents for image capture. In this embodiment, two cameras could be provided, one for each side. Alternatively, the physically delineated portions could be provided only once, in the middle between the two displays 104A and 104B. In this embodiment, a single camera could be used, positioned above the centrally located physically delineated portions. The two screens 104A and 104B could each be a part of two separate tablet computers with their own processors and the like, or both of the two screens could be operated by a single computing device, with one of the two screens connected through a VGA splitter for example. This would allow different windows with different applications to be moved back and forth between the two screens as desired during operation.

Another dual screen embodiment is illustrated in FIG. 12B. In this embodiment, the camera 115 is located in a support arm connecting the two displays. This embodiment may also be placed on a lazy susan type rotating platform as described above. In this embodiment, as well as in the others described herein, an LED light can be placed next to the camera lens to illuminate the physically delineated portion where documents are placed to help insure high quality images are obtained.

In various embodiments, there may be an apparatus for ensuring quality images are taken, such as the cover 180 shown in FIG. 12B. The cover 180 may flatten, hold or otherwise stabilize financial documents, such as checks, in a location while images of the document are taken. The cover 180 may enclose the financial document in a location such as the delineated portion 112 described with respect to various embodiments herein. As shown, the cover 180 may be clear or otherwise transparent. The cover 180 may include anti-reflective properties, which may be implemented for example with suitable material selection and/or surface finishing. The cover 180 may be scratch-resistant. The cover 180 may be formed in the shape of a flat, generally rectangular plate, as shown. The cover 180 may be various thicknesses. In some embodiments, the cover 180 may be ⅛″ thick. In some embodiments, the cover 180 may have a shape corresponding to or otherwise complementing the shape of a delineated portion 112. The cover 180 may also include more than one portion, for example there may be multiple segments that make up the cover 180. The cover 180 may have various shapes and features as well, including for instance indentations or protrusions for gripping the cover 180, for example to open and close the cover 180. The cover 180 may be rotatably attached to the device, such as to the base. In some embodiments, the cover 180 may be hinged to the device, for example with friction hinges. These are merely some examples of the possible shapes, configurations, materials, implementations, etc. of the cover 180, and other suitable variations may be implemented as well. Further, the cover 180 may be included with any of the various embodiments of the POS system, for example with the systems 100, 800, 900, 1000, and 1100 described above.

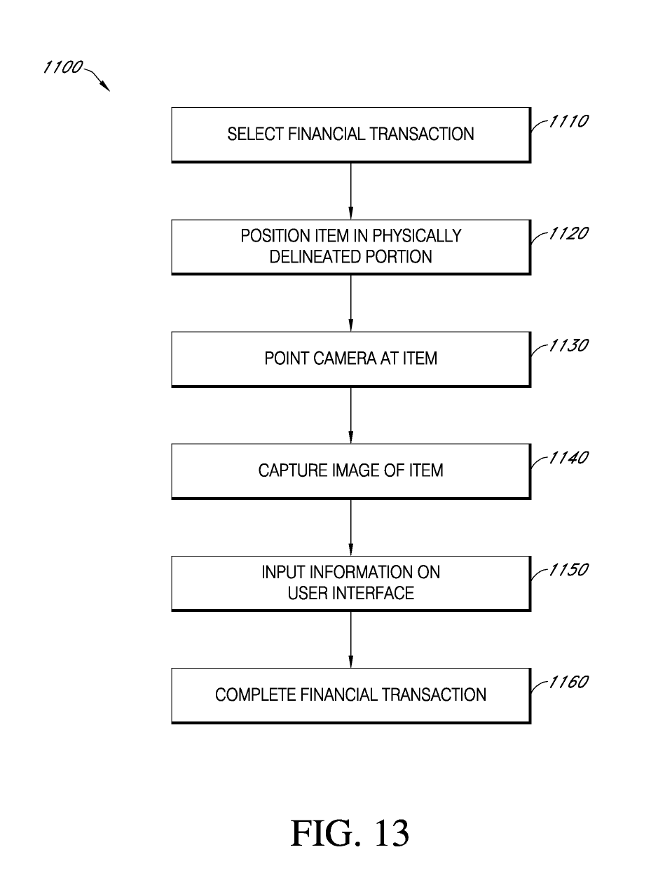

FIG. 13 depicts a flowchart of an embodiment of a method 1100 of using a POS system, such as the POS system 100. The method 1100 may be performed with any of the systems described herein, including the systems 800, 900, 1000, and 1100 described above. The method 1100 may be performed after a user has registered or enrolled to use the POS system. The registration or enrollment may be performed once, after which the method 1100 may be repeatedly performed for multiple transactions.

The method 1100 may include block 1110 wherein a financial transaction is selected. In some embodiments, the base 110 may be placed on a support 20, such as a countertop or table at a merchant's location, to allow the user 10 to initiate a variety of financial services offered by the point-of-sale system 100, such as money transfers. In some embodiments, the user 10 may initiate and complete the transactions and services by him or herself, or the user 10 may initiate the transaction or service and an agent of the merchant may be able to assist or complete the transaction. In some embodiments, the point-of-sale system 100 may provide services for adding money to a prepaid card, check cashing, check deposit, bill pay, refunding cash from a prepaid card, a prepaid card dispenser, or other money transfer services.

In some embodiments, a user 10 may use the point-of-sale system 100 by selecting the service from the user interface 104, and the display screen of the user interface 104 may display the services offered, such as bill payment, remittances, reloading a prepaid card, prepaid card disbursements, check cashing, cash referral, others, or combinations thereof. Once a user 10 selects a service, the user interface 104 may ask the user 10 to input information on the display screen of the user interface 104. For example, the display screen may ask the user 10 to swipe a prepaid card that the user 10 wishes to add funds on, or the display screen may ask a user 10 to take a picture of the check or money order to be deposited or cashed.

In some embodiments, the user 10 may use the web browser of the user interface 104 to perform the money transfer services described above. For example a user 10 may login to a financial institution's website or portal to perform bill pay functions. The website or portal may then instruct the user on how to complete the transaction.

The method 1100 may further include block 1120 wherein an item is positioned in the physically delineated portion. The user 10 may place a check or money order, for example, in the physically delineated portion 112. In some embodiments of block 1120, close the cover 180 may be opened, the financial document placed in the delineated portion 112, and then the cover 180 closed to, for example, flatten the document. An image or picture of the check or money order, for example, may then be taken. The user 10 may also place other documents, such as identification, on the physically delineated portion 112 and image those documents as well.

The method 1100 may further include block 1130 wherein the camera is pointed at the item. The user 10 may tilt, rotate, or otherwise position the user interface 104 and/or the camera 115 such that the camera points to the physically delineated portion 112. The camera 115 may be on a static structure relative to the physically delineated portion, such as described with respect to FIGS. 9 and 11A-11C, such that the camera 115 is already pointing at the item after the item is positioned in block 1120.

The method 1100 may further include block 1140 wherein an image of the item is captured. Block 1140 may also include preparing the image for processing in compliance with a financial institution's specific requirements (e.g. Check21, X9, etc.). The image may be captured by selecting a prompt on the user interface 104. The image may be automatically captured once the system recognizes the item in the portion 112. The image may be automatically captured once the system recognizes the cover 180 has been closed. The image may be captured and processed by the processor of the system.

The method 1100 may further include block 1150 wherein information is input to the system using the user interface. The user 10 may then confirm the amount on the check or input the proper amount, accept or reject the image, confirm other information such as sender/recipient name or account number, etc.

The method 1100 may further include block 1160 wherein the financial transaction is completed. The user interface 104 may process the above described transactions using a merchant or other software application. The user interface 104 may connect to a wireless network (e.g., WiFi hotspot or cellular data connection) and send the transaction information (including the signature and card data) to a financial transaction processing server, which in turn communicates with a card or financial services network. The card or financial services network can send a message to the financial transaction processing server indicating a status of the financial transaction (e.g., success, failure, or other state). In turn, the financial transaction processing server can send the status to the user interface 104. The user interface 104 may also display a message indicating the status to the user 10. After the user 10 finishes the transaction, the user 10 may print a receipt or decline a receipt.

These are just some of the features and functionalities of the systems and associated methods disclosed herein. Other financial-related services and items may be used with the system, even if not explicitly stated. Further, the system 1000 may further include any of the features and functionalities of the system 100 described with respect to FIGS. 1-7 and/or the system 800 described with respect to FIG. 8 and/or the system 900 described with respect to FIG. 9, and vice versa.

Further, although the description above focuses on a POS system that supports a user interface such as a tablet computer, for some applications another type of user interface, such as a large, ATM-like self-service terminal, mobile device, e.g. a smart phone, or other suitable interfaces, could instead or in addition be used with the systems and methods disclosed herein. Some user interfaces, such as a tablet computer, has an advantage of a larger screen than a smart phone, which can make use of the POS system easier and faster for the users 10, such as the customer and/or merchant.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). In some embodiments, the various systems described herein may include or be connected with a terminal management platform. The terminal management platform may be a bus or other device that collects and/or distributes information, commands, etc. from the terminals/clients to backend systems/servers, and vice versa. The terminal management platform may also monitor each terminal (e.g. health, transaction volumes, types, revenue, etc.), deploy updates, allow a back-end technician to configure groups of terminals based on location, demographics, etc.

The computing system can include various types of clients and servers. The client or server may be generally remote from each other and may interact through a communication network. The relationship of client and server may arise by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-26. (canceled)

27. A method for performing financial services using an apparatus comprising a user interface, a camera, an adjustable mount, and a base, wherein the base comprises a physically delineated portion configured to receive an item related to a financial service processed with the apparatus, the method comprising:
selecting a transaction using the user interface;
positioning the item within the physically delineated portion of the base; and
capturing an image with the camera of the item while the item is positioned within the physically delineated portion.

28. The method of claim 27, further comprising positioning the camera such that a lens of the camera points at the item positioned in the physically delineated portion of the base.

29. The method of claim 28, wherein the camera is coupled with the user interface, and wherein positioning the camera comprises positioning the user interface substantially vertically.

30. The method of claim 28, wherein the camera is coupled with the user interface, and wherein positioning the camera comprises positioning the user interface substantially horizontally.

31. The method of claim 27, wherein a field of view of the camera is configured to cover the entire physically delineated portion.

32. The method of claim 27, wherein the item is a check or money order.

33. The method of claim 32, wherein capturing an image of the item comprises capturing an image of the front and back of the item.

34. The method of claim 32, further comprising entering on the user interface an amount indicated on the check or money order.

35. The method of claim 27, wherein the item is at least one of an identification document and a bank check.

36. An apparatus for performing financial services comprising:
a base;
a user interface coupled to the base;
means, coupled with the base, for positioning documents related to financial services processed by the apparatus; and
means for capturing images of the documents positioned with the means for positioning documents.

37. The apparatus of claim 36, further comprising means for flattening the documents when the documents are positioned with the means for positioning documents.

38. An apparatus for performing financial services comprising:
a base;
a mounting structure coupled to the base;
a user interface coupled to the mounting structure;
a camera coupled to the user interface or to the mounting structure and comprising a lens;
wherein the apparatus comprises a surface having defined thereon a physically delineated portion configured to receive an item related to a financial service processed with the apparatus, and
wherein the camera lens is positioned such that the camera lens points at the physically delineated portion defined on the surface.

39. The apparatus of claim 38, further comprising a cover coupled with the base.

40. The apparatus of claim 39, wherein the cover is rotatably coupled with the base.

41. The apparatus of claim 40, wherein the cover is transparent.

42. The apparatus of claim 38, wherein the base is rotatable.

43. The apparatus of claim 38, wherein the surface that contains the physically delineated portion is angled from horizontal.

44. The apparatus of claim 38, wherein the user interface comprises a display.

45. The apparatus of claim 44, wherein the user interface comprises two displays.

46. The apparatus of claim 45, wherein the surface having defined thereon a physically delineated portion is positioned between the two displays.

47. The apparatus of claim 38, wherein the camera is coupled to a rear surface of the mounting structure and the display is coupled to a front surface of the mounting structure.
